(19) United States
(12) Patent Application Publication
(10) Pub. No.: US 2023/0236440 A1
(43) Pub. Date: Jul. 27, 2023

(54) GLASSES WITH LENS FOR TREATING COLOR VISION DEFICIENCY AND METHOD OF MANUFACTURING SAME

(71) Applicant: Khalifa University of Science and Technology, Abu Dhabi (AE)

(72) Inventors: Haider BUTT, Abu Dhabi (AE); Fahad ALAM, Abu Dhabi (AE)

(21) Appl. No.: 18/087,397

(22) Filed: Jan. 13, 2023

Related U.S. Application Data
(63) Continuation-in-part of application No. 17/499,251, filed on Oct. 12, 2021.
Application No. 17/499,251 is a continuation-in-part of application No. 17/307,316, filed on May 4, 2021.

(51) Int. Cl. G02C 7/10

(52) U.S. Cl. CPC G02C 7/104

(57) ABSTRACT

An ophthalmic lens configured to treat color vision deficiency is presented herein. The lens includes a tinted region containing either or both of a first dye that is configured to absorb at least 50% of incident light in a spectral band between 480 nanometers to 500 nanometers and a second dye that is configured to absorb at least 50% of incident light in a spectral band between 550 nanometers to 580 nanometers. A method of manufacturing such a lens and a process of forming set of eyeglasses by an additive manufacturing process is also presented.

This application is a continuation-in-part application and claims the benefit of U.S. Pat. Application No. 17/499,251, filed Oct. 12, 2021, the entire disclosure of which is hereby incorporated by reference, which is a continuation-in-part application and claims the benefit of U.S. Pat. Application No. 17/307,316, filed May 4, 2021, the entire disclosure of which is hereby incorporated by reference.

### BACKGROUND

Human eyes see color via cone cells which are located in a 0.3 mm² spot of the retina near the back of the eye called the fovea centralis. There are three types of cone cells commonly referred to as blue, green and red photoreceptor cells. There are six to seven million cone cells in a human eye of which, 64% are red sensitive, 33% are green sensitive and 3% are blue sensitive.

Color vision deficiency (CVD) is caused when one or more of the cone types are faulty or absent due to mutation. This causes the brain to receive incomplete or incorrect information that prevents distinguishing between different colors. The type of CVD depends on the type of faulty or missing cone cell. Protanomaly results from the sensitivity of red cone cells being shifted to a shorter wavelength. This type of CVD affects 1.08% of males and 0.03% of females. Deuteranomaly occurs when the sensitivity of green cone cells is shifted to a longer wavelength. This is the most common form of CVD and affects 4.63% of males and 0.36% of females. In tritanomaly, the blue cone is displaced. This type of CVD is uncommon and affects only 0.0002% of males. If a cone is missing, the patient is diagnosed as having dichromacy, which is classified into three types:
i) protanopia, where the red cone is missing which affects 1.01% of men and 0.02% of women,
ii) deuteranopia, where the green cones are missing and affecting 1.27% of men and 0.01% of women, and
iii) tritanopia, where the blue cones are missing.
Tritanopia is the most uncommon form of dichromacy and affects only 0.0001% of males. Protanomaly, deuteranomaly, protanopia and deuteranopia are all classified under the common term “red-green color blindness.” The most severe kind of CVD is the monochromacy which arises when no cones or only blue cones are present. This is extremely rare and affects 0.00003% of males and results in the inability to perceive any colors.

“Normal” color vision is trichromatic, with color being created using all three different types of cones with the activation level in all three cones allowing the brain to determine the color. When light of a specific wavelength enters the eye, it excites the cones cells to a known activation level, and the combined signal from the different types of cone cells is analyzed by the brain and the color is observed. For example, when light of a wavelength of 520 nm is observed by normal individuals, the cones are activated at different levels: 0% for blue, 90% for green, and 55% for red. However, for protanomaly, the activation of the red cone cells to stimulation by 520 nm light is increased to 75% and for deuteranomaly, the activation of green cone cells is lowered to 60%. This causes the red and green cones to be activated to similar levels in protanomaly and deuteranomaly which results in the wrong color being perceived.

Despite the fact that many individuals have adapted to live with CVD, this condition affects them in many ways. In many countries, people who have CVD are not allowed to drive as some may not distinguish between the different colors of traffic lights and road signs. Suffering from CVD also prohibits individuals from entering some professions such as pilot or firefighter due to safety concerns over their visual disadvantage.

### SUMMARY

According to one or more aspects of the present disclosure, a lens of a set of glasses includes a tinted region containing at least one selected from a list consisting of a first dye configured to absorb at least 50% of incident light in a spectral band between 480 nanometers to 500 nanometers and a second dye configured to absorb at least 50% of incident light in a spectral band between 550 nanometers to 580 nanometers. In some embodiments the region includes the whole lens. In other embodiments the region includes a layer within the lens.

According to one or more aspects of the present disclosure, a process of forming an ophthalmic contact lens using an additive manufacturing process includes the steps providing a first liquid resin solution, forming the contact lens from the first liquid resin solution using an additive manufacturing process and curing the first liquid resin solution by exposure to ultraviolet light, dipping the contact lens formed by the additive manufacturing process into a second liquid resin solution, and curing the second liquid resin solution by exposure to ultraviolet light.

### DESCRIPTION OF THE DRAWINGS

FIG. 1 is a front view of a contact lens having a tinted region, according to some embodiments.

FIG. 2 is a front view of the contact lens of FIG. 1 disposed within an eye, according to some embodiments.

FIG. 3 is a cross section view the contact lens of FIG. 1, according to some embodiments.

FIG. 4 is a cross section view a contact lens having two layers of the tinted region containing different colored dyes, according to some embodiments.

FIG. 5 is a flow chart of a method of forming the contact lenses of FIGS. 1-4, according to some embodiments.

FIG. 6 is a flow chart of a process of forming a contact lens using an additive manufacturing process, according to some embodiments.

FIGS. 7A and 7B are a front views and side cross-section views respectively of contact lenses formed by an additive manufacturing process prior to dip coating according to some embodiments.

FIGS. 8A and 8B are the front views and side cross-section views respectively of the contact lenses of FIGS. 7A and 7B after dip coating according to some embodiments.

FIGS. 9A and 9B are a front views of the contact lenses formed by an additive manufacturing process according to some embodiments.

FIG. 10 is schematic view of an apparatus for forming a nanopattern on the surface of a contact lens according to some embodiments.

FIG. 11A is a front view of a contact lens with a nanopattern formed thereon according to some embodiments.

FIG. 11B is a close-up view of the nanopattern of FIG. 11A according to some embodiments; and

FIG. 12 is a perspective view of a contact lens and support structures on a print bed of an additive manufacturing apparatus according to some embodiments.

FIG. 13 is a perspective view of a pair of eyeglasses having a pair of lenses which include a tinted region, according to some embodiments.

FIG. 14 is a top view of a model of a pair of the lenses of the eyeglasses shown in FIG. 13, according to some embodiments.

FIG. 15 is a perspective view of a pair of the lens of the eyeglasses shown in FIG. 13 as formed using additive manufacturing on a build plate with support structure or pillars, according to some embodiments.

FIG. 16 is a top view of another model of the pair of lenses of the eyeglasses shown in FIG. 13, according to another embodiment.

FIG. 17 is a perspective view of a pair of the lens of the eyeglasses comparable to the lenses shown in FIG. 13 as formed using additive manufacturing directly on a build plate, according to this other embodiment.

FIG. 18 is a partial cross section view the lens of FIG. 17 along line 18-18, according to some embodiments.

FIG. 19 is a cross section view a lens of FIG. 17 along line 18-18 having at least two layers according to some embodiments.

FIG. 20 is a graph showing the transmission spectra printed lenses tinted with Atto 565, one of the wavelength filtering dyes, according to some embodiments.

FIG. 21 is a graph showing the transmission spectra printed lenses tinted with Atto 488, one of the wavelength filtering dyes, according to some embodiments.

FIG. 22 is a graph showing the transmission spectra printed lenses tinted with both Atto 565 and Atto 488, according to some embodiments.

FIG. 23 is a schematic representation of a Vickers Hardness Tester.

FIG. 24 flow chart regarding manufacture of the lenses and frame by additive manufacturing, according to some embodiments.

FIG. 25 is a top view of a model 2500 which includes a model of the frame and a model of the right bow or temple, and a model of the left bow or temple of the eyeglasses shown in FIG. 13 as it is being formed, according to some embodiments.

FIG. 26 is a perspective view of a frame and temples of the eyeglasses shown in FIG. 13 as formed using additive manufacturing on a build plate with support structure or pillars, according to some embodiments.

### DETAILED DESCIRPTION

### Contact Lens

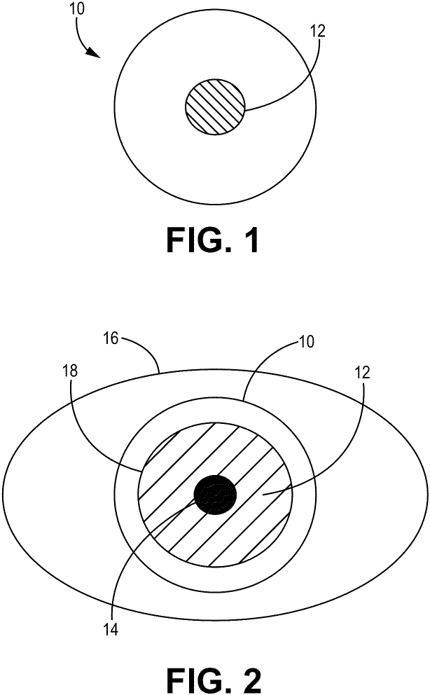

A contact lens that may be used to treat color vision deficiency (CVD) is described herein. As illustrated in FIGS. 1 and 2, the contact lens 10 has a tinted region 12 that is sized, shaped and arranged to cover the pupil 14 of the eye 16 in which the contact lens 10 is disposed. The tinted region 12 is preferably sized to cover the pupil 14 without covering a significant portion of the iris 18 surrounding the pupil so that it will not be easily noticeable that the contact lens wearer is using the contact lens 10 to treat CVD. Since the pupil 14 changes size depending on the intensity of incident light, the tinted region 12 may be sized to cover the pupil 14 for lower light intensity conditions in which cone vision is still active, but not necessarily cover the entire pupil 14 when vision is predominately rod based vision. The cones that sense the color on the retina are concentrated at the center of the fundus, that is, the central fovea and the surrounding elliptical shape, and the range corresponds to a viewing angle of about 10°. Since the radius of the cornea surface corresponding to this viewing angle of 10° is about 1.058 mm, a tinted portion having a diameter of about 2.1 mm is sufficient to correct CVD. The tinted region 12 may be sized so that it covers very little of the iris 18 so that it is not easily observable that the contact lens user is wearing a contact lens to treat CVD. The tinted region of the contact lens may cover less than 10% of the iris and preferably less than 5% of the iris.

The tinted region 12 includes a dye that is configured to block at least 50%, and preferably 50to 100%, of incident light in the 480-500 nanometer wavelength range to treat blue-yellow color blindness (tritanomaly and tritanopia). The tinted region 12 may also or alternatively include a dye that is configured to block at least 50%, and preferably 50 to 100%, of incident light in the 550 to 580 nanometer wavelength range to treat red-green color blindness. The percentage of light blocked by the dyes is dependent upon the particular needs of the contact lens wearer.

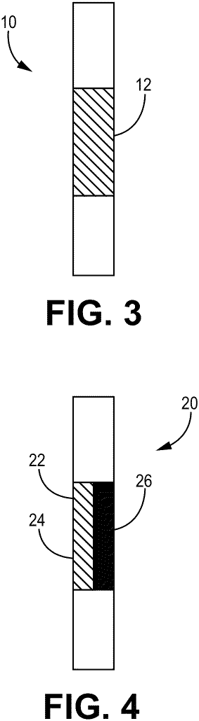

In one embodiment, the contact lens 10 is made of a 2-hydroxyethyl methacrylate (HEMA) material, which has a tinted region 12 shown in FIG. 3 that contains a first rhodamine dye having an absorption peak at 564 nanometers. This first rhodamine dye is a carboxytetramethylrhodamine dye, such as ATTO 488 manufactured by ATTO-TEC GmbH. The concentration of the dye is in the range of in the range of 0.000015% to 0.00003% by weight which is effective to block 50% to 100% of incident light in the 480 to 500 nanometer wavelength range. The contact lens 10 has an absorption peak in the 505 to 515 nanometer wavelength range. The first carboxytetramethylrhodamine dye is crosslinked with the HEMA material to provide a stable tinted region from which the dye will not leach into the eye or into a phosphate buffered saline contact lens storage solution. Carboxytetramethylrhodamine dyes are considered nontoxic for corneal cells. The shift in the absorption peak in the contact lens 10 to the 505 to 515 nanometer wavelength range is caused by the cross linking of the first carboxytetramethylrhodamine dye with the HEMA material.

In a second embodiment, the contact lens 10 is made of HEMA material and has a tinted region 12 shown in FIG. 3 that contains a second rhodamine dye having an absorption peak at 500 nanometers. This second rhodamine dye is a carboxytetramethylrhodamine dye, such as ATTO 565 also manufactured by ATTO-TEC GmbH. The concentration of the dye is in the range of 0.000015% to 0.00003% by weight which is effective to block 50% to 100% of incident light in the550 to 580 nanometer wavelength range. The contact lens 10 has an absorption peak in the 560 to 570 nanometer wavelength range. The second carboxytetramethylrhodamine dye is crosslinked with the HEMA material to provide a stable tinted region from which the dye will not leach into the eye, or a phosphate buffered saline contact lens storage solution.

In a third embodiment, the contact lens 20 has a tinted region 22 with two distinct layers 24, 26 as shown in FIG. 4. The first layer formed of a HEMA material with a first dye concentration effective to block 50% to 100% of incident light in the 480-515 nanometer wavelength range and a second layer formed of a HEMA material with a second dye concentration which is effective to block 50% to 100% of incident light in the 550 to 580 nanometer wavelength range. The contact lens 20 has two distinctive dips in its spectra transmitted through the contact lens 20 at wavelengths of 495 nm and 565 nm. In an alternative embodiment, the first layer formed of a HEMA material with a first dye concentration effective to block 50% to 100% of incident light in the 550 to 580 nanometer wavelength range and a second layer formed of a HEMA material with a second dye concentration which is effective to block 50% to 100% of incident light in the 480-515 nanometer wavelength range.

The first and second contact lenses 10 may be made using a method of mixing a solution comprising polyethylene glycol dimethacrylate (PEGDA), 2-hydroxyethyl methacrylate (HEMA), and 2,2-dimethoxy-2-phenylacetophenone (photoinitiator) with the first or second carboxytetramethylrhodamine dye. The ratio of the HEMA to PEGDA to photoinitiator is in the range of 20:1:1 to 10:10:1, by volume. The concentration of the carboxytetramethylrhodamine dye is in the range of in the range of 0.000015% to 0.00003% by weight. The mixture is then poured into a mold and the cured by exposure to an ultraviolet light source. The light source may provide energy in the range of 100 to 1200 µJ/cm2 at a wavelength of 365 nm. The mixture may be exposed to the ultraviolet light for a period of 2 to 30 minutes in order to cure the mixture.

In another embodiment, the two dyes are added in certain proportions into the mixture (comprising polyethylene glycol dimethacrylate (PEGDA), 2-hydroxyethyl methacrylate (HEMA), and 2,2-dimethoxy-2-phenylacetophenone and then formed into a lens with a single layer rather two separate layers, one for each dye.

The third contact lens 20 may be made by adding the steps of mixing another solution comprising polyethylene glycol dimethacrylate (PEGDA), 2-hydroxyethyl methacrylate (HEMA), and 2,2-dimethoxy-2-phenylacetophenone (photoinitiator) with whichever carboxytetramethylrhodamine dye was not used previously. The ratio of the HEMA to PEGDA to photoinitiator is in the range of 20:1:1 to 10:10:1, by volume. The concentration of the carboxytetramethylrhodamine dye is in the range of in the range of 0.000015% to 0.00003% by weight. The mixture is then poured into the mold over the previously formed layer and the cured by exposure to an ultraviolet light source. The light source may provide energy in the range of 100 to 1200 µJ/cm2 at a wavelength of 365 nm. The mixture may be exposed to the ultraviolet light for a period of 2 to 30 minutes in order to cure the mixture.

Alternatively, the contact lenses 10, 20, may be formed by an additive manufacturing (3D printing) process using a digital light processor printer having an ultraviolet light source and containing the solutions as described above.

The tinted area of the contact lens is stable when stored a hydroxypropyl methylcellulose (artificial tears) solution, such as TEARS NATURALE™ II manufactured by Alcon, or when stored in a phosphate buffered saline solution, such as ACUVUE™ REVITALENS® solution manufactured by Johnson & Johnson, for a period of at least one week.

Testing performed with deuteranopia subjects using the contact lenses 10 with the first dye to block 90% of light in the 480 to 500 nanometer wavelength range experienced 15% improvement in correctly identifying plates in the Ishihara test commonly used to evaluate CVD, while the contact lenses 10 with the second dye to block 90% of light in the 550 to 580 nanometer wavelength range provided about 20% improvement and the contact lens 20 provided about 23% improvement. Testing performed with deuteranomaly subjects using the contact lenses 10 with the first dye experienced a decrease of about 5% in correctly identifying plates in the Ishihara test while the contact lens 10 with the second dye provided about 11% improvement and the contact lens 20 provided about 25% improvement. Based on this testing, it is recommended that the contact lens 10, 20, used, the dye, and the dye concentration is customized to the individual person with CVD.

While the contact lenses 10, 20 described above are hydrogel contact lenses formed primarily from HEMA material, alternative contact lenses including the inventive features may be silicon hydrogel or hard contact lenses with a thin layer of HEMA material containing the tinted region described above.

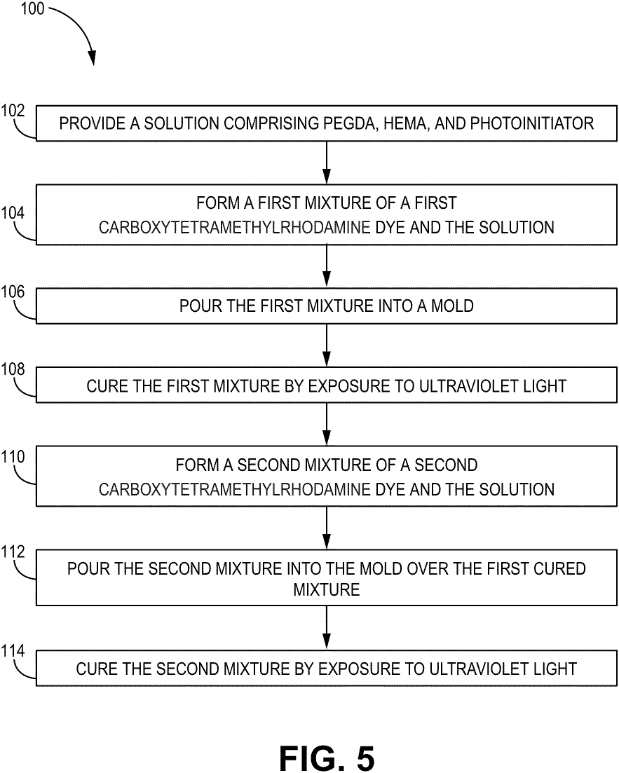

A method 100 of forming a contact lens 10 with a tinted region 12 configured to treat CVD is shown in FIG. 5. The method 100 includes the steps of:

STEP 102, PROVIDE A SOLUTION COMPRISING PEGDA, HEMA, AND PHOTOINITIATOR, includes providing a solution that includes 2-hydroxyethyl methacrylate (HEMA), polyethylene glycol dimethacrylate (PEGDA), and a photoinitiator, e.g., 2,2-dimethoxy-2-phenylacetophenone;

STEP 104, FORM A FIRST MIXTURE OF A FIRST CARBOXYTETRAMETHYLRHODAMINE DYE AND THE SOLUTION includes forming a first mixture of a first carboxytetramethylrhodamine dye and the solution of HEMA, PEGDA, and the photoinitiator;

STEP 106, FORM THE FIRST MIXTURE INTO A DESIRED SHAPE, includes forming the first mixture into a desired shape by pouring the mixture in to a mold shaped to form the contact lens 10 or using an additive manufacturing process;

STEP 108, CURE THE FIRST MIXTURE BY EXPOSURE TO ULTRAVIOLET LIGHT, includes curing the first mixture in the mold by exposure to ultraviolet light, e.g., ultraviolet light with a wavelength of 365 nm having an intensity in the range of 100 to 1200 µJ/cm2 for a period of 2 to 30 minutes or by using a digital light processor 3D printer having an ultraviolet light source;

STEP 110, FORM A SECOND MIXTURE OF A SECOND CARBOXYTETRAMETHYLRHODAMINE DYE AND THE SOLUTION, is an optional step in forming the contact lens 20 that includes forming a second mixture of a second carboxytetramethylrhodamine dye and the solution of HEMA, PEGDA, and the photoinitiator;

STEP 112, FORM THE SECOND MIXTURE INTO A DESIRED SHAPE OVER THE FIRST CURED MIXTURE, is an optional step in forming the contact lens 20 that includes pouring the second mixture into the mold over the first cured mixture that remains in the mold to form a desired shape of the second mixture or forming the second mixture into a desired shape over the first cured mixture using an additive manufacturing process; and

STEP 114, CURE THE SECOND MIXTURE BY EXPOSURE TO ULTRAVIOLET LIGHT, is an optional step in forming the contact lens 20 that includes curing the second mixture by exposure to ultraviolet light, e.g., ultraviolet light with a wavelength of 365 nm having an intensity in the range of 100 to 1200 µJ/cm2 for a period of 2 to 30 minutes or by using a digital light processor 3D printer having an ultraviolet light source.

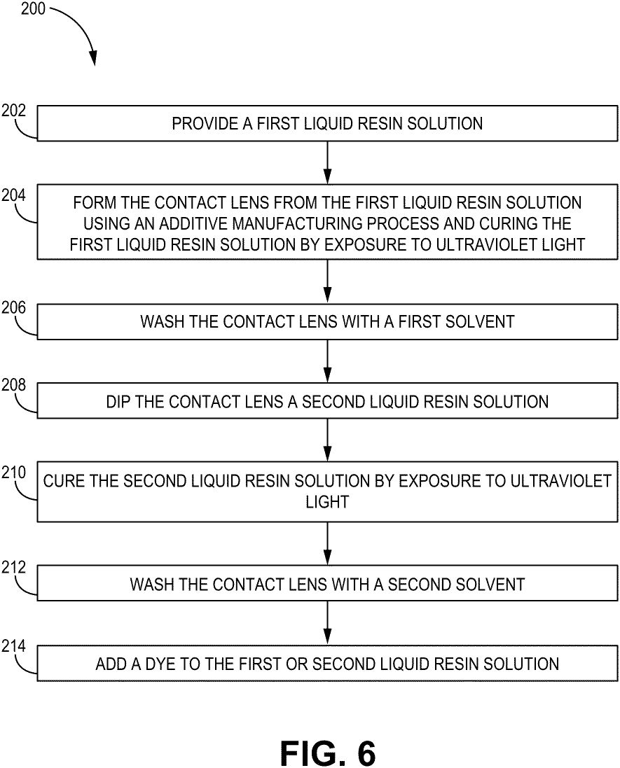

A process 200 of forming a contact lens 10 with a tinted region 12 configured to treat CVD using an additive manufacturing process, commonly known as a 3D printing process, is shown in FIG. 6. The process 200 includes the steps of:

STEP 202, PROVIDE A FIRST LIQUID RESIN SOLUTION, includes providing a first liquid resin solution. Two examples of a suitable first resin solution are a first mixture of 2-hydroxyethyl methacrylate (HEMA), polyethylene glycol dimethacrylate (PEGDA), and a photoinitiator such as 2,2-dimethoxy-2-phenylacetophenone or diphenyl (2,4,6-trimethylbenzoyl) phosphine oxide (TPO). The ratio of HEMA to PEGDA may be in a range of 3:1 to 1:1 and the concentration of the photoinitiator may be in the range of 2% to 10% by weight of the solution. Preferably, the ratio of HEMA to PEGDA is 1:1 and the concentration of the photoinitiator is 2.5% by weight. The composition of the solution has been found to optimize the optical transmittance of the contact lens 10;

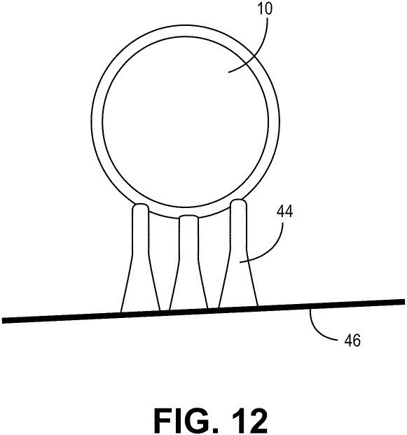

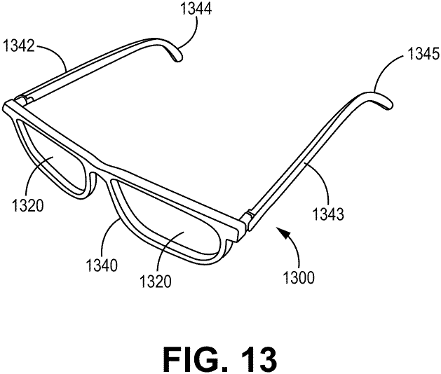

STEP 204, FORM THE CONTACT LENS FROM THE FIRST LIQUID RESIN SOLUTION USING AN ADDITIVE MANUFACTURING PROCESS AND CURING THE FIRST LIQUID RESIN SOLUTION BY EXPOSURE TO ULTRAVIOLET LIGHT, includes loading the first liquid resin solution into an additive manufacturing device, such as a digital light printer (DLP) or a masked stereolithography apparatus (MSLA) that is programmed to form the lens shape of the contact lens 10 and any removeable support structures 44 needed during the process of forming the contact lens as shown in FIG. 12. The contact lens 10 is then formed from the first liquid resin solution using the additive manufacturing process. DLP and MSLA are preferable over other additive manufacturing processes, such as selective laser sintering (SLS) and fused deposition modeling (FDM) due to higher resolution of printing and reduced thickness of the printed layers. The thickness of the layers forming the support structures 44 and lens 10 may vary from 25 to 100 micron. It was found that the layers forming the lens 10 are preferably about 25 micron to reduce the “stair-step” at the edges of each layer. The lens 10 is preferably formed such that the disc of the lens is generally perpendicular to the print bed 46 of the additive manufacturing device on which the support structures 44 are formed as illustrated in FIG. 12. It was found that forming the lens 10 with this orientation to the print bed produced the smoothest lens surface and provided a smaller support structure 44, thereby minimizing the material used to form the support structures 44 that will eventually be removed from the lens and discarded. The support structures 44 are typically limited to 5 layers, also to minimize discarded material. Each layer is cured by exposure to ultraviolet light, e.g., ultraviolet light with a wavelength of 365 nm having an intensity in the range of 100 to 1200 µJ/cm2 for a period of 15 to 35 seconds. The optimal cure time for the support structures 44 was found to be in a range of 30 to 35 seconds and the optimal cure time for the lens 10 was found to be in a range of 15 to 20 seconds;

STEP 206, WASH THE CONTACT LENS WITH A FIRST SOLVENT TO REMOVE UNCURED FIRST LIQUID RESIN SOLUTION AFTER CURING THE FIRST LIQUID RESIN SOLUTION BY EXPOSURE TO ULTRAVIOLET LIGHT, is an optional step including washing the contact lens with a first solvent, e.g., isopropyl alcohol, to remove any remaining portions of the first liquid resin solution that remain uncured after exposing the first liquid resin solution to ultraviolet light;

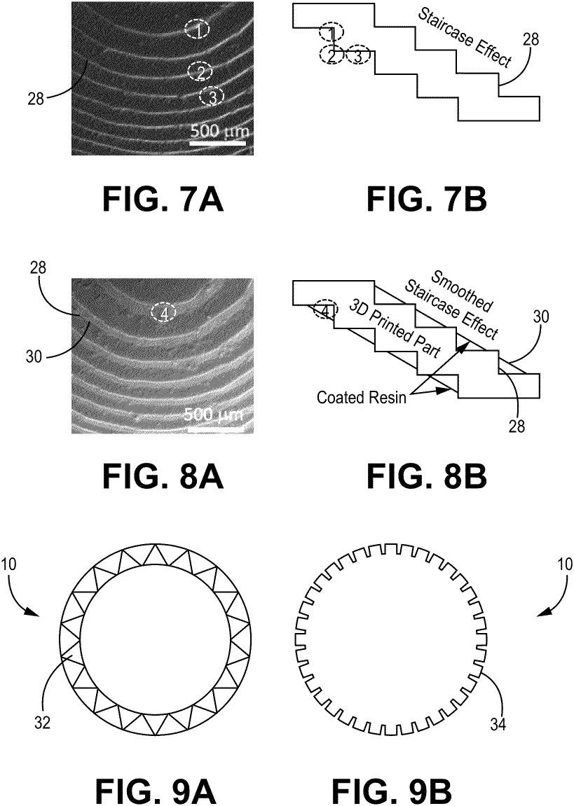

STEP 208, DIP THE CONTACT LENS FORMED BY THE ADDITIVE MANUFACTURING PROCESS INTO A SECOND LIQUID RESIN SOLUTION, includes dip coating the contact lens that was formed by the additive manufacturing process by submerging the contact lens in a second liquid resin solution for a period of 30 seconds to one minute. The second liquid resin solution may preferably be the same as the first resin solution. FIGS. 7A and 7B show stair step features 28 that are created between the layers forming the contact lens. The inventors have found that dipping the contact lens in the second liquid resin solution 30 reduces and fills in stair step features 28 at the edges of the layers as shown in FIGS. 8A and 8B, thereby improving surface smoothness and performance of the contact lens. The inventors discovered that post processing the context lens by dip coating improves optical transmittance of the resulting contact lens by about 30%;

STEP 210, CURE THE SECOND LIQUID RESIN SOLUTION BY EXPOSURE TO ULTRAVIOLET LIGHT, includes curing the second liquid resin solution by exposure to ultraviolet light for a period of one to two minutes;

STEP 214 WASH THE CONTACT LENS WITH A SECOND SOLVENT TO REMOVE UNCURED SECOND LIQUID RESIN SOLUTION AFTER CURING THE SECOND LIQUID RESIN SOLUTION BY EXPOSURE TO ULTRAVIOLET LIGHT, is an optional step including washing the contact lens with a second solvent which may be the same as the first solvent, e.g., isopropyl alcohol, to remove any remaining portions of the second liquid resin solution that remain uncured after exposing the second liquid resin solution to ultraviolet light; and

STEP 212, ADD A FIRST DYE OR A SECOND DYE TO THE FIRST OR SECOND LIQUID RESIN SOLUTION, is an optional step that includes adding a first dye configured to absorb at least 50% of incident light in a spectral band between 480 nanometers to 500 nanometers or a second dye configured to absorb at least 50% of incident light in a spectral band between 550 nanometers to 580 nanometers to the first or second liquid resin solution so that the contact lens may be used to treat CVD. The dyes may preferably be a carboxytetramethylrhodamine dye when the first or second liquid resin solution is a mixture of HEMA, PEGDA, and 2,2-dimethoxy-2-phenylacetophenone or a food grade dye when the first or second liquid resin solution is a mixture of HEMA, PEGDA, and TPO. The carboxytetramethylrhodamine dyes are added to have a concentration of 0.000015% to 0.00003% by weight while the food grade dyes are added to have a concentration of about 2% by volume.

The additive manufacturing process may also be used to form rectangular microchannels 32, as shown in FIG. 9A, or triangular microchannels 34 as shown in FIG. 9B, at the edge of the contact lens 10. These microchannel 32, 34 may act as optical transducers by observing a change in the microchannel geometries with the help of images captured by a camera, e.g., a smart phones camera. For example, dry eye sensing can be performed by monitoring the spacing between or shape of the microchannels 32, 34.

The inventors have also discovered that the surface finish and optical transmittance of the contact lens formed by the additive manufacturing process may be further improved by placing a thin film of PVC plastic on top of the print bed of the additive manufacturing apparatus thereby allowing easier removal of the contact lens from the print bed and a reduction in damage to the contact lens while removing it from the print bed.

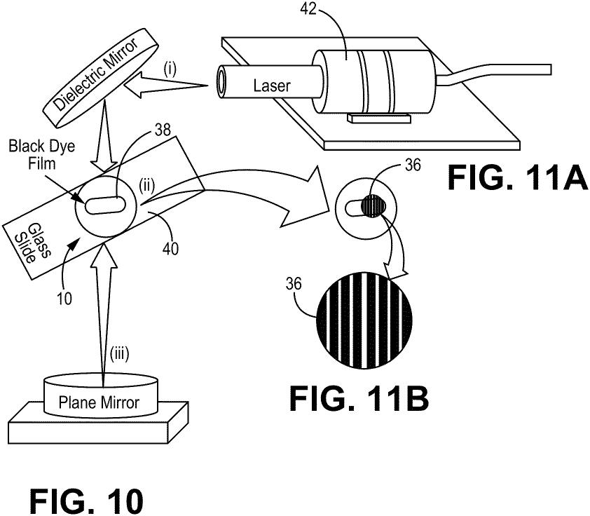

A nanopattern 36 may be formed on the surface of the contact lens via a holographic laser ablation apparatus as shown in FIG. 10. The holographic nanopattern 36 integrated on the contact lens 10 shown in FIGS. 11A and 11B can be utilized as a transducer to sense electrolyte concentration in the tears, which may indicate a physiological state of the eye. Sensing the electrolyte concentration in tears could provide early detection of disease conditions in the eye.

The laser ablation process is carried out via direct laser interference patterning (DLIP) method in holographic Denisyuk reflection mode. To facilitate the interaction between the laser beams and the lens material, a black color dye 38 is placed on the surface of the contact lens.

The process of producing the nanopattern on the lens material may include the following steps:
a) cleaning the contact lens 10 with isopropyl alcohol and placing it on a glass slide 40;
b) applying a laser absorbing film 38, e.g., a synthetic black dye to the surface of the contact lens 10;
c) generating the holographic nanopattern 36 on the contact lens 10 due to the interference between the incident and reflected laser beams.

Upon exposure to the laser 42, the ablative interference fringes are developed thereby forming a one-dimensional (1D) nanopattern 36 on the surface of the 3D printed contact lens 10.

Because of the high energy in the constructive interference regions, the nanogrooves are produced on the surface of the contact lens as shown in the FIG. 11B. A high-power interference beam is produced when incident beam and reflected beam interact and result in ablation of the surface of the contact lens 10. The grating spacing depends on the angle of exposure. For example, a grating spacing of 925 nm can be created at an exposure angle of 35° from the horizontal plane.

Accordingly, contact lenses 10, 20 configured for treating CVD and a method 100 and process 200 for manufacturing these contact lenses 10, 20 is presented herein. The use of using a dyed region to block out light with undesirable wavelengths, instead of quantum dots or nanoparticles, provides a lower cost and simplicity which make the contact lenses 10, 20 ideal for mass production. In addition, the carboxytetramethylrhodamine dye is nontoxic to the corneal tissue of the eye. Once the carboxytetramethylrhodamine dye is cross-linked with the HEMA material forming the lens, it is resistant to leaching into tears in the eye or contact lens storage solution, thereby providing a stable color in the tinted regions, 12, 22. It has also been found that crosslinking the carboxytetramethylrhodamine dye with the HEMA material does not affect the dye’s chemical structure. In addition, the carboxytetramethylrhodamine dye has high thermal stability, has high photostability, and is slightly hydrophilic.

### Eyeglasses

FIG. 13 is a perspective view of a pair of eyeglasses 1300 having a pair of lenses 1320 which include a tinted region, according to some embodiments. The eyeglasses also have a frame 1340 which holds the pair of lenses 1320. The frame also includes a right bow or temple 1342 and a left bow or temple 1343 which are hingedly attached to the frame 1340. The bows 1342, 1343 have temple ends 1344, 1345 which are adapted to fit over or loop over the wearer’s ear to hold the frame in place on the wearer’s face and specifically hold the pair of lenses 1320 over the wearer’s eyes. The frame 1340 and the lenses 1320 are formed by additive manufacturing or printing. Additive manufacturing uses data computer-aided-design (CAD) software or 3D object scanners to direct hardware to deposit material, layer upon layer, in precise geometric shapes. As its name implies, additive manufacturing adds material to create an object as a series of layers.

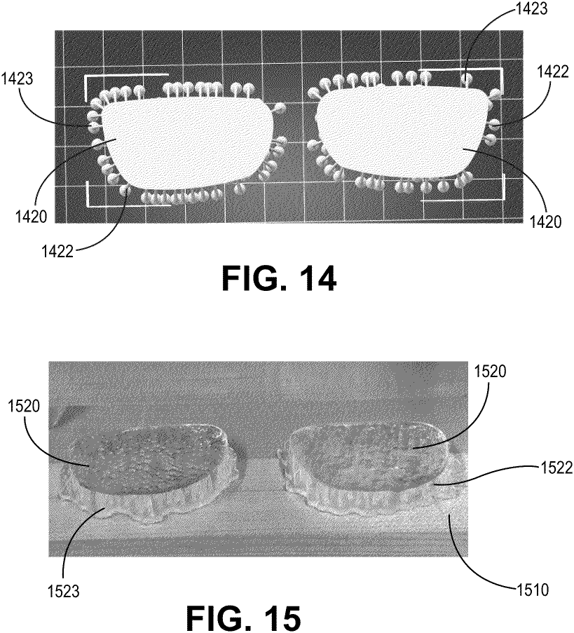

FIG. 14 is a top view of a model 1400 of a pair of the lenses 1420 of the eyeglasses shown in FIG. 13, according to some embodiments. The model 1400 is “sliced” using a computer-aided design software, according to some embodiments. The slices correspond to layers which are printed to form the actual object. The model 1400 pair of lenses 1420 include a support structure 1422 in the form of a plurality of pillars 1423 formed about the periphery of each lens of the pair of lenses 1420. In this embodiment, a 3D model of the lenses 1420 and frame 1340 for 3D printing were prepared using a computer-aided designing (CAD) software, available from SOLIDWORKS of Waltham, Massachusetts. The dimensions of the glass or lenses 1420 were sized so that the lenses 1420 fit well in the frame 1340. The designed CAD models of the lenses 1420 and frame 1340 were saved in stereolithography (STL) format and were converted into Geometric Code (G-code) through the 3D printer’s slicing tool (PrusaSlicer 2.3.3. available from PrusaSlicer of Prague, Czech Republic). It should be noted that in other embodiments, the lenses can be modeled based on an object, such as another pair of lenses, using a three-dimensional object scanner.

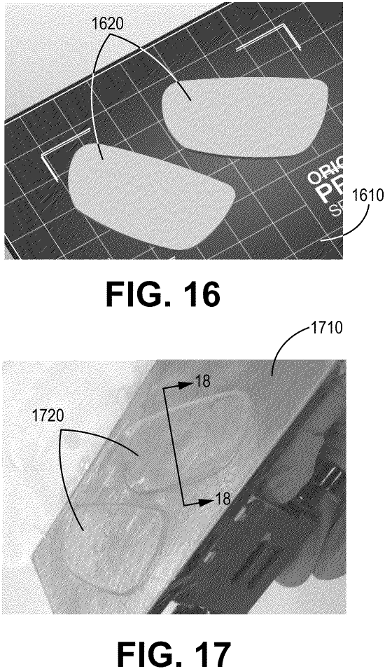

FIG. 15 is a perspective view of a pair of the lens 1520 of the eyeglasses 1300 shown in FIG. 13 as formed using additive manufacturing on a build plate 1510 with support structure 1522 or pillars 1523, according to some embodiments. Additive manufacturing is used to print a plurality of thin layers of material from the model 1400 shown in FIG. 14. The resulting pair of lenses 1520 are post processed and cured. Added details about the additive manufacturing process and post processing will follow the discussion of FIGS. 15 and 16.

FIG. 16 is a top view of another model 1600 of the pair of lenses 1620 of the eyeglasses 1300 shown in FIG. 13, according to another embodiment. In this model, a pair of lenses 1620 is formed directly onto a build plate 1610. The model 1600 does not have a support structure or individual pillars forming the support structure. The pair of lenses 1620 are built using additive manufacturing right on the build plate 1610. In this embodiment, a 3D model of the lenses 1620 and for 3D printing were prepared using a computer-aided designing (CAD) software, available from SOLIDWORKS of Waltham, Massachusetts. The dimensions of the glass or lenses 1620 and the frame 1340 were optimized so that the lenses resulting from the model 1600 fit well in the frame 1340. The designed CAD models of the lenses 1620 were saved in stereolithography (STL) format and were converted into Geometric Code (G-code) through the 3D printer’s slicing tool (PrusaSlicer 2.3.3. available from PrusaSlicer of Prague, Czech Republic). It should be noted that in other embodiments, the model 1600 of the lenses 1620 can be sliced using a three-dimensional object scanner.

FIG. 17 is a perspective view of a pair of the lens 1720 of the eyeglasses comparable to the lenses 1320 shown in FIG. 13 as formed using additive manufacturing directly on a build plate 1710, according to this other embodiment. Additive manufacturing is used to print a plurality of thin layers of material from the model 1600 shown in FIG. 16. The resulting pair of lenses 1720 are post processed and cured which will be further detailed below.

The lenses 1320, 1520, 1720 used in the glasses include tinting that block a certain amount of specific wavelengths of light to treat color vision deficiency (CVD). The tinting was the result of mixing at least one dye into the photocurable resin used to form the lenses 1320, 1520, 1720. A first dye is mixed with the clear photocurable resin and is mixed in an amount configured to absorb at least 50% of incident light in a spectral band between 480 nanometers to 500 nanometers. A second dye is also mixable with the clear photo curable resin and is mixed in an amount configured to absorb at least 50% of incident light in a spectral band between 550 nanometers to 580 nanometers to the first or second liquid resin. In some embodiments, both the first dye and the second dye are mixed into the clear photo curable resin to produce lenses 1320, 1520, 1720 that absorbs at least 50% of incident light in a spectral band between 480 nanometers to 500 nanometers, and at least 50% of incident light in a spectral band between 550 nanometers to 580 nanometers. In other embodiments, just the first dye is mixed with the clear photocurable resin to produce lenses 1320, 1520, 1720 that absorb 50% of incident light in its respective spectral band. In another embodiment, just the second dye is mixed with the clear photocurable resin to produce lenses 1320, 1520, 1720 that absorb 50% of incident light in its respective spectral band. In yet another embodiment, a mixture of the first dye and the clear photo curable resin is used to form a first layer of the lenses 1320, 1520, 1720 and a mixture of the second dye with the clear photo curable resin is used to form a second layer of the lenses 1320, 1520, 1720. The resulting eyeglasses 1300 are customizable. The concentration of the first and second dyes can be varied. For example, the concentrations can be varied to be 0.5%, 1.0% or 1.5%. One or both dies can be formed into the lenses 1320, 1520, 1720.

For 3D printing of glass lenses 1320, 1520, 1720 that included both dyes in the lenses, The wavelength filtering dyes (Atto dyes) are available from Sigma-Aldrich of Burlington, Massachusetts. The Atto dyes (Atto 565 and Atto 488) were mixed individually as well as in combined form, in a clear photocurable resin. In this particular embodiment, the clear photocurable resin is DentaClear available from ASIGA of Alexandria, NSW, Australia. Dimethyl Sulfoxide (DMSO) was utilized as the solvent to prepare the liquefied dye solution. For that purpose, 1 mg powder of dyes were dissolved in 1 mL of DMSO followed by mixing with the help of vortex for 5 min to obtain the liquid form of dyes. The prepared solution (1 mL DMSO + 1 mg dye solution) was added to 100 mL of DentaClear photocurable resin. Next, more liquid resins were added to get the lower concentrations of the dyes in the resin to the desired level. As mentioned previously, the concentrations used generally could be 0.5%, 1.0% or 1.5%. It should be noted that other concentrations could be used to form the lenses 1320, 1520, 1720. Also of note, the Atto dyes have been extensively studied for life science applications and exhibit a negligible safety concern. For lenses containing both dyes, the above procedure was done for each of the dyes, Atto 565 and Atto 488, and added to the clear photocurable resin. For lenses 1320, 1520, 1720 containing just one of the wavelength filtering dyes was added to the clear photocurable resin. As will be discussed below, some of the lenses 1320, 1520, 1720 include a layer containing one of the wavelength filtering dyes, and another layer containing the other of the wavelength filtering dyes.

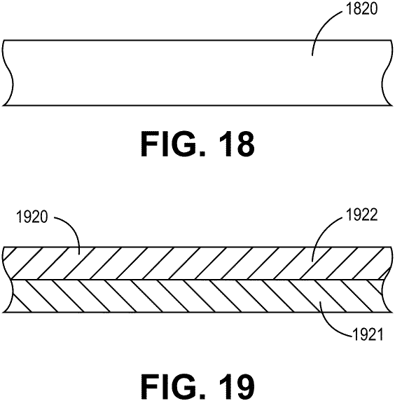

FIG. 18 is a partial cross section view the lens of FIG. 17 along line 18-18, according to some embodiments. The cross-sectional view shown in FIG. 18 shows a lens 1820 that is 3D printed as multiple layers from the same clear photocurable resin. In other words, the lens 1820 is 3D printed to form a lens 1820 that is homogenous or substantially homogenous. In one embodiment, the resin used to form the lens 1820 is tinted with one wavelength filtering dye. In another embodiment, the resin used to form the lens 1820 is tinted with at least two wavelength filtering dyes. The result is a lens that is made of a substantially homogeneous material.

FIG. 19 is a cross section view a lens of FIG. 17 along line 18-18 having at least two layers 1921, 1922 according to some embodiments. The cross-sectional view shown in FIG. 19 shows a lens 1920 that is 3D printed as multiple layers 1921, 1922 from differently tinted clear photocurable resin. In other words, the lens 1920 is 3D printed to form a lens 1920 that has a first layer 1921 that includes a first tinting and has a second layer 1922 that includes a second tinting. A first resin mixture 1911 that includes a first wavelength filtering dye is used to form the first layer 1921 of the lens 1920. Once the first layer 1921 has been printed and cure, the remaining first mixture 1911 is removed from the 3D printing vat of the 3D printing apparatus, and a second resin mixture 1912 is placed in the vat and is used to print the second layer 1922 on top of the first layer 1921. The result is a lens 1920 with a first layer 1921 that includes a first tinting and has a second layer 1922 that includes a second tinting. Of course, it should be noted that there are variations of this multilayer approach. For example, one layer might be sandwiched between two other layers. In still another embodiment, a first tinted layer and second tinted layer could be sandwiched between two untinted or clear layers. The layers are considered portions of the lens 1920. In some embodiments, the portions could be layers that are partial layers that do not extend to the outer periphery of the lens 1920. The result is a lens 1920 that includes a first layer containing a first layer 1921 including a first wavelength filtering tint produced from a clear photocurable resin having a first wavelength filtering dye and a second layer 1922 including a second wavelength filtering tint produced from a clear photocurable resin having a second wavelength filtering dye. The layers could be partial layers or partial portions of the lens 1920. Although the layers 1921, 1922 shown in FIG. 19 are about the same in thickness, it should also be noted that the thickness of the layers 1921, 1922 could differ from one another.

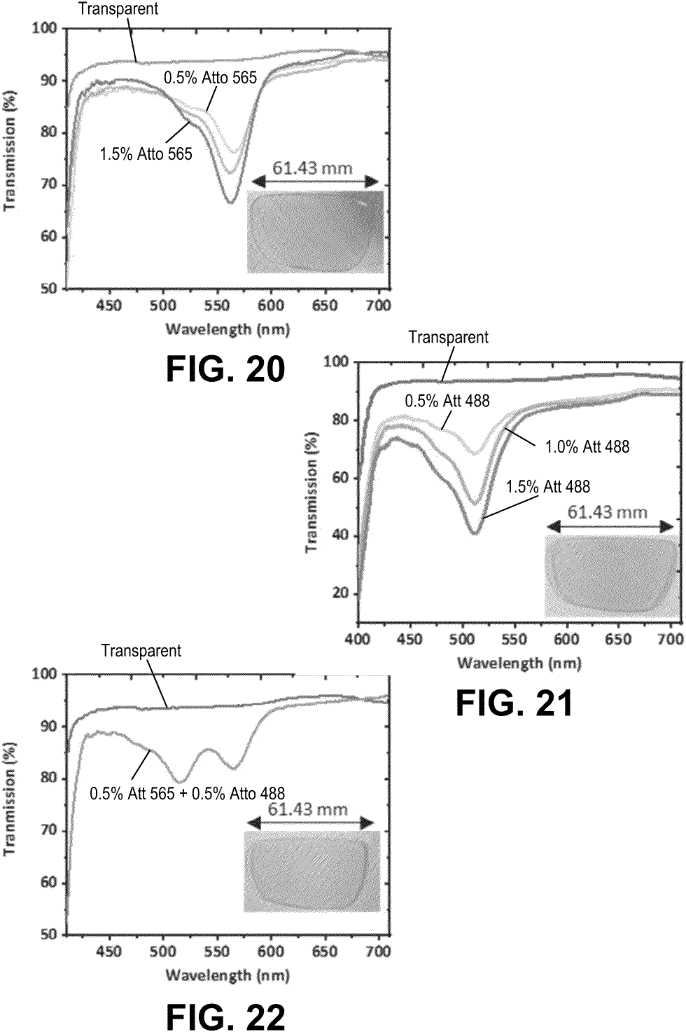

FIG. 20 is a graph showing the transmission spectra printed lenses tinted with Atto 565, one of the wavelength filtering dyes, according to some embodiments. As can be seen, the various concentrations of dye produce a sharp decline in the wavelength of light in the 550-580 nanometer range. In other words, the wavelength filtering dye Atto 565 produces a lens that very effectively filters out light in the 550-580 nanometer range.

FIG. 21 is a graph showing the transmission spectra printed lenses tinted with Atto 488, one of the wavelength filtering dyes, according to some embodiments. As can be seen, the various concentrations of dye produce a sharp decline in the wavelength of light in the 480 - 510 nanometer range. In other words, the wavelength filtering dye Atto 488 produces a lens that very effectively filters out light in the 480 - 510 nanometer range.

FIG. 22 is a graph showing the transmission spectra printed lenses tinted with both Atto 565 and Atto 488, according to some embodiments. As can be seen, the combination of these two dyes filters out some of the light in the associated ranges. The presence of both dyes produces two distinct dips at 565 and 508 nanometers. However, the amount of adsorption is not as high as much the amount of adsorption in the two separate layers. The dips in FIG. 22 are not as pronounced as in FIGS. 20 and 21, indicating less adsorption. This suggests that a lens or pair of lenses with two separate layers may be better than a set of lenses with both dyes in one layer in that more of the light is filtered out with the two separate layers when compared to the lens formed with both dyes therein.

3D printing of the lenses 1320, 1520, 1720 was carried out utilizing a masked sterolithography 3D printing apparatus (MSLA). The MSLA 3D printer used is a Prusa SL1 available from Prusa Research of Prague, Czech Republic.^{[24]} The 3D printing parameters play a crucial role on the resulting properties of the manufactured parts. Hence, the printing parameters (curing time and layer thickness) are optimized to achieve the desired optical and mechanical properties. The utilized printing parameters are presented in Table 1, and the 3D printing process has been discussed with respect to FIGS. 13 -17 above. The steps discussed above include 1) CAD model preparation, 2) slicing, and 3) 3D printing, and 4) post processing (washing). Prior to printing, a PVC film was attached on top of the build plate 1510, 1710, and then, the dye-mixed resin was poured into resin vat. In one embodiment, the lenses 1710 were printed directly on the surface of the PVC film to achieve a smooth surface finish. A Stereolithographic Printer is equipped with a laser that forms liquid resin into a plastic and lays down row after row of the formed plastic into an object such as lenses 1320, 1520, 1720.

The lenses 1510, were built on a support structure and pillar. Pads were added to the PVC film before printing.

When a two layer type lens is made, the process is essentially the same as above. An additional step in the process happens after the first layer or portion of the lens 1510, 1710 is formed from multiple rows of formed plastic. The vat is emptied of the first mixture of clear photocurable resin mixed with the first wavelength filtering dye. The lens and vat are cleaned with IPA to remove uncured dye. The vat is then filled with a second mixture of clear photocurable resin with a second wavelength filtering dye. Once the vat is filled with the second mixture, the additive manufacturing process is used to add the second layer including multiple rows of formed plastic atop the first layer. According to one embodiment, the layer thickness used in the additive manufacturing process, the curing time, the print speed and other printing parameters are set forth in the following Table 1.

TABLE 1

Printing parameters for the fabrication process

| | |
|---|---|
| Printing Parameters | Specifications |
| Layer thickness | 25 microns for glasses and 50 microns for frame |
| Curing time | Glasses: Burn layers -30 seconds, normal layers -15 seconds |
| | Frame: Burn layers -30 seconds, normal layers -20 seconds |
| Print speed | 6 seconds per layer |
| Vat tilt time | 5 seconds (Fast), 8 seconds (Slow) |
| Support | Glasses: No support, printed directly on the build platform |
| | Frame: At the bottom most of the model, pillar diameter - 1 mm |
| Brim | 1.6 mm length only in frame |
| Pad | Glasses: No pad |
| | Frame: Below the object (1 mm thick) |

After 3D printing, the parts were washed in Isopropyl Alcohol (IPA) and sonicated to ensure all uncured resin was removed from the printed parts. Finally, the support structures were removed. Other post processing includes polishing the lenses 1510, 1710 with a fine grit polish.

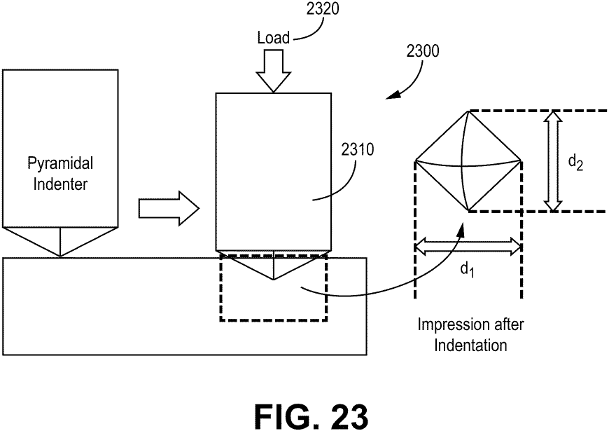

Another post processing procedure includes testing the lens 1520, 1720 for hardness. FIG. 23 is a schematic representation of a Vickers Hardness Tester 2300. A Vickers Hardness Tester 2300 includes a diamond-shaped indenter 2310 and a load 2320 used to produce a force at the diamond shaped indenter 2310. A hardness test can be done on each lens 1520, 1720 or can be done using a sampling scheme where a selected number of a batch of lenses produced in a manufacturing process is tested. A hardness test measures an important property for lenses, namely the surface hardness and scratch resistance. Most generally, the Vicker’s hardness test consists of applying a force or load on the test material using a diamond indenter, to obtain an indentation. The depth of indentation on the material gives the value of hardness for the specimen. In general, the smaller the indentation, the harder the object is. In this particular embodiment, the Vickers hardness test was conducted using, Duramin-A2500, and by applying 5Kgf load and a dwell time of 10 s. Before the indentation test, samples were cleaned with ethanol. As shown schematically in FIG. 23, the diagonals of indent (d1 and d2) are measured using an optical microscope. The Vickers hardness (HV) was calculated by using the dimensions of the diagonals, d1 and d2, and the expression from the following equations (i. and ii) .

$${H}_{V} = \frac{2 F s i n \frac{136 °}{2}}{{d}^{2}}$$

$${H}_{V} = 1.854 \frac{F}{{d}^{2}}$$

Where, d is the Arithmetic mean of the two diagonals, d₁ and d₂ in mm.

It is also contemplated that other hardness tests could be used to determine the hamdess of the lenses. For example, a Brinnell hardness test could be used to characterize the hardness and scratch resistance of the lenses.

Additionally, if the hardness test yields a hardness out of a selected range, the manufacturing process, namely the thickness of each row of material added in the additive process, and the curing time can be varied to produce a lens 1320, 1520, 1720 within the selected range.

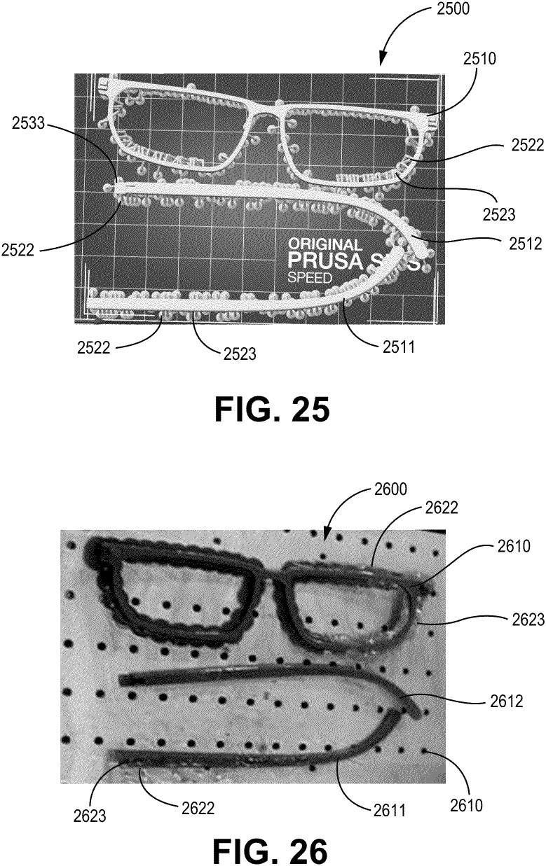

FIG. 25 is a top view of a model 2500 which includes a model 2510 of the frame 1340 and a model 2511 of the right bow or temple 1341, and a model 2512 of the left bow or temple 1342 of the eyeglasses shown in FIG. 13, according to some embodiments. FIG. 26 is a perspective view of a 2640 of the eyeglasses 1300 shown in FIG. 13 as formed using additive manufacturing on a build plate 2610 with support structure 2622 or pillars 2623, according to some embodiments. The modeling and printing of the frame and bows or temples will now be discussed with respect to both FIGS. 25 and 26. The model 2500 of the frame and bows are “sliced” using a computer-aided design software, according to some embodiments. The slices correspond to layers which are printed to form the actual object, namely the frame and temples of the eyeglasses 1300. The model 2500 includes a support structure 2522 in the form of a plurality of pillars 2523 formed about the periphery of each sub model, 2510, 2511, 2512. In this embodiment, a 3D model 2500 of the eyeglasses 1300 for 3D printing were prepared using a computer-aided designing (CAD) software, available from SOLIDWORKS of Waltham, Massachusetts. The dimensions of the eyeglasses were sized so that the lenses 1420 fit well in the frame 1340. The designed CAD models 2500 of the eyeglasses were saved in stereolithography (STL) format and were converted into Geometric Code (G-code) through the 3D printer’s slicing tool (PrusaSlicer 2.3.3. available from PrusaSlicer of Prague, Czech Republic). It should be noted that in other embodiments, the lenses can be modeled based on an object, such as another pair of lenses, using a three-dimensional object scanner.

3D printing of the frames 1340 and bows or temples 1342, 1342 was carried out utilizing a printing apparatus (masked sterolithography 3D printing apparatus (MSLA). The MSLA 3D printer used is a Prusa SL1 available from Prusa Research of Prague, Czech Republic.) To print the frames and bows, a gray resin, such as Wanhao 3D Printing High Tenacity Resin available from Wanhao Factory Co., LTD of Hangzhou, Zhejiang, China was utilized. The 3D printing parameters play a crucial role on the resulting properties of the manufactured parts. Hence, the printing parameters (curing time and layer thickness) are selected to achieve the desired mechanical properties of the frames and bows. The utilized printing parameters are also presented in Table 1, and the 3D printing process includes 1) CAD model preparation, 2) slicing, and 3) 3D printing, and 4) post processing (washing) of the frames. The printed frame 2640 and the bows 2642, 2643 are shown in FIG. 26. Post processing also includes removal of the support structure 2522 from each of the printed bows 2642, 2643 and from the frame 2640. Prior to printing, a PVC film was attached on top of the build plate 2610. Pads were added to the PVC film before printing. The gray resin was poured into resin vat and the frames 2640 and bows 2642, 2643 were printed on a pad on the surface of the PVC film. The Stereolithographic Printer used for printing of the frame 2640 and the bows 2642, 2643 is equipped with a laser that forms liquid resin into a plastic and lays down row after row of the formed plastic into an object such as frame 2640 and the bows 2642, 2643.

The mechanical properties of the glasses and frame materials (DentaClear and Gray resins) were characterized by tensile and three-point bending tests. Mechanical properties were determined and are presented in Table 2 below. The mechanical properties from both materials demonstrated their durability as glass lenses and frame materials, which is apparent when comparing them with materials employed in similar applications. The flexural properties (from three-point bending test) indicated that the frame manufactured via 3D printing will not break easily even if it was subjected to folding or bending. Overall, the spectacles (including both the lenses and frame) exhibited excellent durability.

TABLE 2

| Samples | Strength [MPa] | | Modulus [MPa] | | Elongation [%] | |
|---|---|---|---|---|---|---|
| | Tensile | Bending | Tensile | Bending | Tensile | Bending |
| Dentaclear | 21.9 ± 0.2 | 3.2 ± 0.2 | 5.56 ± 0.31 | 1.25 ± 0.02 | 11.5 ± 1.2 | 25.1 ± 4.1 |
| Gray Resin | 12.5 ± 0.4 | 3.1 ± 0.3 | 2.68 ± 0.42 | 1.01 ± 0.01 | 14.3 ± 1.8 | 33.2 ± 2.7 |

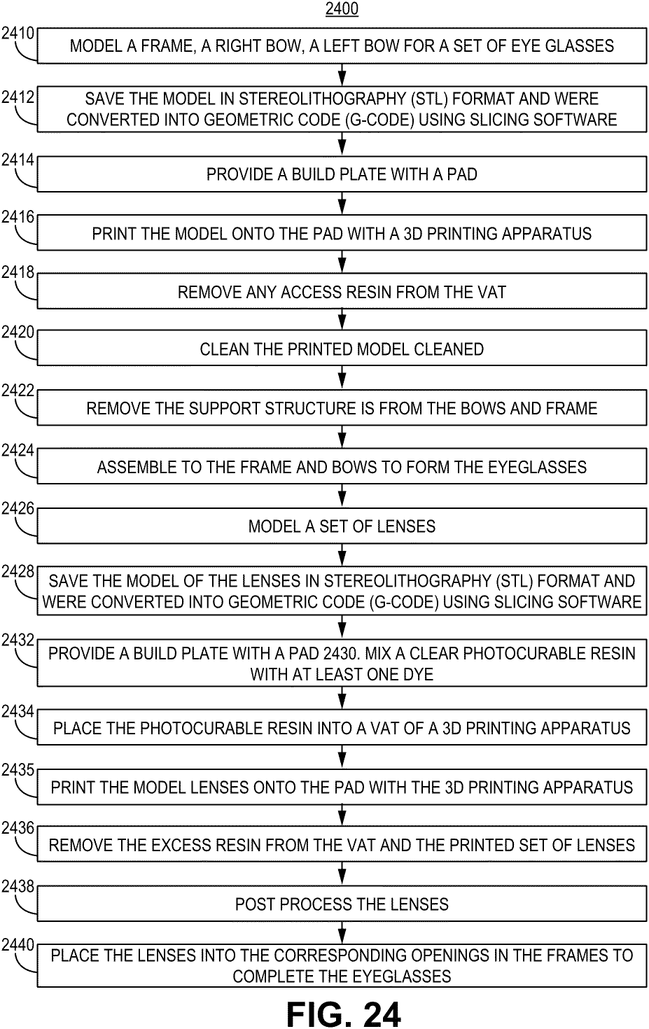

FIG. 24 flow chart 2400 regarding manufacture of the lenses and frame by additive manufacturing, according to some embodiments. Initially, a frame, a right bow, a left bow are modeled 2410. The model will include a support structure with multiple individual supports or pillars. The model is saved in stereolithography (STL) format and were converted into Geometric Code (G-code) using slicing software 2412. A build plate is provided with a pad 2414. A 3D printing apparatus then prints the model onto the pad 2416. The printing is done in a vat of resin. Once complete, the excess resin is removed from the vat 2418 and the printed model is cleaned 2420. The support structure is removed 2422 from the bows and frame, and the bows are assembled to the frame to form the eyeglasses 2424. A set of lenses are also modeled 2426. The model of the lenses is saved in stereolithography (STL) format and were converted into Geometric Code (G-code) using slicing software 2428. A build plate is provided with a pad 2430. A clear photocurable resin is mixed with at least one dye 2432. The photocurable resin is placed into a vat of a 3d printing apparatus 2434. The 3D printing apparatus then prints the model lenses onto the pad 2435. The excess resin is removed from the vat and the printed set of lenses 2436. The lenses can be further post processed 2438. The lenses are then placed into the corresponding openings in the frames to complete the eyeglasses 2440.

It should be noted that in some embodiments, the lenses are formed of a first layer of a resin dyed with a first wavelength filtering dye, and the formed of a second layer of a resin dyed with a second wavelength filtering dye. The second layer is formed on top of the first layer. This adds the further elements of emptying the vat of the unused portion of the resin dyed with the first wavelength filtering dye and cleaning the partially formed lenses and the vat. The resin dyed with a second wavelength filtering dye is then placed in the vat and printing is continued using the resin with the second wavelength filtering dye.

In summary, a set of eyeglasses includes a printed frame having a first opening and a second opening, a first ophthalmic printed lens for the first opening in the printed frame, and a second ophthalmic printed lens for the second opening in the printed frame. In one embodiment, both of the first ophthalmic printed lens and the second ophthalmic printed lens formed with a first dye therein configured to absorb at least 50% of incident light in a spectral band between 550 nanometers and 580 nanometers. In another embodiment, both of the first ophthalmic printed lens and the second ophthalmic printed lens are formed with a first dye therein configured to absorb at least 50% of incident light in a spectral band between 550 nanometers and 580 nanometers and the first dye therein in a first portion of both of the first ophthalmic printed lens and the second ophthalmic printed lens. In one embodiment, the portion is inside both of the first ophthalmic printed lens and the second ophthalmic printed lens. For example, the first portion could be a sandwiched layer or other inner layer within the first and second ophthalmic printed lens. In another embodiment, the first ophthalmic printed lens and the second ophthalmic printed lens are formed with a second dye therein. The second dye is configured to absorb at least 50% of incident light in a spectral band between 480 nanometers and 500 nanometers. The second dye therein in a second portion of both of the first ophthalmic printed lens and the second ophthalmic printed lens inside both of the first ophthalmic printed lens and the second ophthalmic printed lens. In one embodiment, the second portion is an inner layer or a layer sandwiched within both the first ophthalmic printed lens and the second ophthalmic printed lens.

In one embodiment, both of the first ophthalmic printed lens and the second ophthalmic printed lens are formed with a first dye therein configured to absorb at least 50% of incident light in a spectral band between 550 nanometers and 580 nanometers, and a second dye therein configured to absorb at least 50% of incident light in a spectral band between 480 nanometers and 500 nanometers. In other words, the first dye and second dye are inside both of the first ophthalmic printed lens and the second ophthalmic printed lens. In other words, these are not coatings on the outside of an otherwise clear lens.

In another embodiment, the first dye is in a first portion of both the first ophthalmic printed lens and the second ophthalmic printed lens, and the second dye is in a second portion of both the first ophthalmic printed lens and the second ophthalmic printed lens. The first portion and the second portion being different portions within both of the first ophthalmic printed lens and the second ophthalmic printed lens. In one embodiment, the first portion is a first layer and the second portion is a second layer of both the first ophthalmic printed lens and the second ophthalmic printed lens.

A printed ophthalmic lens for eyeglasses includes a first major exterior surface and a second major exterior surface. The printed ophthalmic lens also includes a first interior portion between the first major exterior surface and the second major exterior surface. The first interior portion includes a first dye configured to absorb at least 50% of incident light in a spectral band between 550 nanometers and 580 nanometers. In another embodiment, the interior portion also includes second dye therein configured to absorb at least 50% of incident light in a spectral band between 480 nanometers and 500 nanometers. In still another embodiment, the printed ophthalmic lens for eyeglasses of claim 10 further includes a second interior portion that includes second dye therein configured to absorb at least 50% of incident light in a spectral band between 480 nanometers and 500 nanometers. The second portion different than the first interior portion. In one embodiment, the first interior portion is a first layer and the second interior portion is a second layer. In some embodiments, the first layer and the second layer extend to all the edges of the printed ophthalmic lens.

A process of forming an ophthalmic lens includes providing a first liquid resin solution with at least one of a first dye therein configured to absorb at least 50% of incident light in a spectral band between 550 nanometers and 580 nanometers, and a second dye therein configured to absorb at least 50% of incident light in a spectral band between 480 nanometers and 500 nanometers. The ophthalmic lens from the first liquid resin solution is formed using an additive manufacturing process and is cured by exposing the first liquid resin solution to ultraviolet light.

While the invention has been described with reference to an exemplary embodiment(s), it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the disclosed embodiment(s), but that the invention will include all embodiments falling within the scope of the appended claims.

1. A set of eyeglasses comprising:
a printed frame having a first opening and a second opening;
a first ophthalmic printed lens for the first opening in the printed frame; and
a second ophthalmic printed lens for the second opening in the printed frame, both of the first ophthalmic printed lens and the second ophthalmic printed lens formed with a first dye therein configured to absorb at least 50% of incident light in a spectral band between 550 nanometers and 580 nanometers.

2. The set of eyeglasses of claim 1 wherein both of the first ophthalmic printed lens and the second ophthalmic printed lens formed with a first dye therein configured to absorb at least 50% of incident light in a spectral band between 550 nanometers and 580 nanometers, the first dye therein in a first portion of both of the first ophthalmic printed lens and the second ophthalmic printed lens inside both of the first ophthalmic printed lens and the second ophthalmic printed lens.

3. The set of eyeglasses of claim 2 wherein the first portion of both the first ophthalmic printed lens and the second ophthalmic printed lens inside both of the first ophthalmic printed lens and the second ophthalmic printed lens is an inner layer of both the first ophthalmic printed lens and the second ophthalmic printed lens.

4. The set of eyeglasses of claim 1 wherein both of the first ophthalmic printed lens and the second ophthalmic printed lens formed with a second dye therein configured to absorb at least 50% of incident light in a spectral band between 480 nanometers and 500 nanometers, the second dye therein in a second portion of both of the first ophthalmic printed lens and the second ophthalmic printed lens inside both of the first ophthalmic printed lens and the second ophthalmic printed lens.

5. The set of eyeglasses of claim 4 wherein the second portion of both the first ophthalmic printed lens and the second ophthalmic printed lens inside both of the first ophthalmic printed lens and the second ophthalmic printed lens is an inner layer of both the first ophthalmic printed lens and the second ophthalmic printed lens.

6. The set of eyeglasses of claim 1 wherein both of the first ophthalmic printed lens and the second ophthalmic printed lens are formed with a first dye therein configured to absorb at least 50% of incident light in a spectral band between 550 nanometers and 580 nanometers, and a second dye therein configured to absorb at least 50% of incident light in a spectral band between 480 nanometers and 500 nanometers, the first dye and second dye within both of the first ophthalmic printed lens and the second ophthalmic printed lens.

7. The set of eyeglasses of claim 6 wherein the first dye is in a first portion of both the first ophthalmic printed lens and the second ophthalmic printed lens, and the second dye is in a second portion of both the first ophthalmic printed lens and the second ophthalmic printed lens, the first portion and the second portion being different portions inside both of the first ophthalmic printed lens and the second ophthalmic printed lens is an inner layer of both the first ophthalmic printed lens and the second ophthalmic printed lens.

8. The set of eyeglasses of claim 7 wherein the first portion is a first layer and the second portion is a second layer of both the first ophthalmic printed lens and the second ophthalmic printed lens, and the first layer and the second layer within both the first ophthalmic printed lens and the second ophthalmic printed lens.

9. A printed ophthalmic lens for eyeglasses comprising:
a first major exterior surface;
a second major exterior surface; and
an interior portion between the first major exterior surface and the second major exterior surface, the interior portion including a first dye configured to absorb at least 50% of incident light in a spectral band between 550 nanometers and 580 nanometers.

10. The printed ophthalmic lens for eyeglasses of claim 9 wherein the first interior portion also includes second dye therein configured to absorb at least 50% of incident light in a spectral band between 480 nanometers and 500 nanometers.

11. The printed ophthalmic lens for eyeglasses of claim 10 further comprising a second interior portion that includes second dye therein configured to absorb at least 50% of incident light in a spectral band between 480 nanometers and 500 nanometers, the second portion different than the first interior portion.

12. The printed ophthalmic lens for eyeglasses of claim 11 herein the first interior portion is a first layer and the second interior portion is a second layer.

13. The printed ophthalmic lens for eyeglasses of claim 11 wherein the first layer and the second layer extend to all the edges of the printed ophthalmic lens.

14. A process of forming an ophthalmic lens, comprising:
providing a first liquid resin solution with at least one of
a first dye therein configured to absorb at least 50% of incident light in a spectral band between 550 nanometers and 580 nanometers; and
a second dye therein configured to absorb at least 50% of incident light in a spectral band between 480 nanometers and 500 nanometers; and
forming the lens from the first liquid resin solution using an additive manufacturing process and curing the first liquid resin solution by exposure to ultraviolet light.
